(19) United States
(12) Patent Application Publication
(10) Pub. No.: US 2012/0224947 A1
(43) Pub. Date: Sep. 6, 2012

(54) TRASH COLLECTING DEVICE

(75) Inventors: James R. Fitzpatrick, Stratford, CT (US); John V. Goodrich, Stratford, CT (US)

(73) Assignee: Garbo Grabber, LLC, Stratford, CT (US)

(21) Appl. No.: 13/411,166

(22) Filed: Mar. 2, 2012

Related U.S. Application Data
(63) Continuation-in-part of application No. 29/408,335, filed on Dec. 9, 2011.
(60) Provisional application No. 61/449,442, filed on Mar. 4, 2011.

(51) Int. Cl. B65F 1/00; B65B 67/12; B65B 67/00

(52) U.S. Cl. 414/808; 49/460; 248/99

(57) ABSTRACT

The present invention is directed to a trash collecting device that includes a substantially circular piece having a sidewall surrounding an interior region, a surface extending from the sidewall towards the interior region, a handle and a first opening within the surface. The trash collecting device also includes a retaining ring dimensioned for nested engagement within the interior region of the substantially circular piece. The handle of the substantially circular piece may include a substantially cylindrical portion attached to the surface, and the handle may be positioned between the first opening and the sidewall. The trash collecting device is configured to securely hold a bag between the retaining ring and the substantially circular piece when at least a portion of the retaining ring is held within the interior region of the substantially circular piece.

### CROSS-REFERENCE TO RELATED APPLICATIONS

This application claims priority to U.S. Provisional Appl. No. 61/449,442 filed Mar. 4, 2011, which is hereby incorporated by reference in its entirety, and is a continuation-in-part of U.S. application Ser. No. 29/408,335 filed Dec. 9, 2011, which is pending and is hereby incorporated by reference in its entirety.

### BACKGROUND OF THE INVENTION

1. Technical Field

The present invention relates generally to collection of trash and the like. More particularly, it relates to a trash collecting device with which a conventional trash bag can be held in an open position so that trash can easily be inserted therein.

2. Description of the Background Art

Highway maintenance workers were observed picking up debris and trash along major highways. They all were performing the task in the same manner utilizing a steel pointed paper picker or picking by hand trying to fill plastic bags with the discarded materials. This appeared to be an arduous task that was caused by the inability of the maintenance worker to keep the plastic bag in an open position while attempting to put the discarded materials into the bag. Windy weather conditions and the movement of traffic attributed to the blowing of the plastic bag while being held by the workers. Under these conditions the process appeared to be unproductive as the workers had to focus much of their attention on keeping the bags open during the work operation. What is needed is a device that would make it easier for the worker to hold the bag open thereby eliminating the struggle of trying to keep the bag open while depositing the debris.

### SUMMARY OF THE INVENTION

The present invention is designed to overcome the above noted limitations that are attendant upon the use of conventional thin plastic trash bags and, toward this end, it contemplates the provision of a novel trash collecting device to which a plastic trash bag can be easily assembled and then easily transported by the user.

It is an object of the present invention to provide a novel trash collecting device that facilitates use of conventional thin plastic trash bags.

It is also an object to provide such a trash collecting device which allows trash to be disengaged from the user's paper picker without the need for the user to handle the trash.

Still another object is to provide such a trash collecting device which provides a user with an inexpensive and easy way to hold open conventional thin plastic trash bags so trash can be inserted therein.

It is an additional object to provide such a trash collecting device which will not damage the trash bag being held thereby.

A further object is to provide such a trash collecting device which may be readily and economically fabricated and will enjoy a long life in operation.

It has now been found that the foregoing and related objects can be readily attained in a trash collecting device in accordance with an exemplary embodiment of the present invention, that includes a substantially circular piece having a sidewall surrounding an interior region, a surface extending from the sidewall towards the interior region, a handle and a first opening within the surface, and a retaining ring dimensioned for nested engagement within the interior region of the substantially circular piece. The handle may include a substantially cylindrical portion attached to the surface, a second opening defined within the surface and a third opening defined within the surface and positioned on a side of the cylindrical portion opposite the second opening. The handle may be positioned between the first opening and the sidewall, and the first opening may include at least one extension of the opening defining a channel extending from the opening towards the handle.

The sidewall of the trash collecting device defined above may include at least one protrusion extending from the sidewall towards the interior region, and the retaining ring may include an inner surface and an outer surface, and a groove is defined at least over a portion of the outer surface of the retaining ring.

The groove is dimensioned for receipt of the at least one protrusion, and the groove and the at least one protrusion are configured to operationally engage to securely hold at least a portion of the retaining ring within the interior region of the substantially circular piece.

Furthermore, the trash collecting device is configured to securely hold a bag between the retaining ring and the substantially circular piece when at least the portion of the retaining ring is held within the interior region of the substantially circular piece.

It has further been found that the foregoing and related objects can be readily attained in a cover piece for a trash collecting device in accordance with another exemplary embodiment of the present invention, where the cover piece may include a sidewall defining an interior region of the cover piece, a surface extending from the sidewall towards the interior region, a handle connected to the surface, and a first opening within the surface. The handle in accordance with this exemplary embodiment may be positioned between the first opening and the sidewall, and the first opening may include at least one extension of the first opening defining an open channel in the surface extending from the first opening towards the handle.

In accordance with this exemplary embodiment of the present invention, the cover piece is configured for removable attachment to a retaining ring. The retaining ring is dimensioned to fit in a nested engagement within the interior region the cover piece, and the cover piece is configured to securely hold at least a portion of a bag when the retaining ring is placed in the nested engagement within the interior region of the cover piece.

In accordance with this exemplary embodiment of the present invention, the cover piece may also include at least one protrusion extending from the sidewall towards the interior region, and the at least one protrusion is configured to engage the retaining ring to securely hold the retaining ring in the nested engagement within the interior region of the cover piece.

In accordance with this exemplary embodiment of the present invention, the cover piece and the retaining ring are formed from a resilient material so as to be configured to produce a resilient clamping action on the bag. The resilient material may be comprised of a plastic resin or the like.

In accordance with this exemplary embodiment of the present invention, the handle may include a rounded rod portion, and the cover piece may also include a second opening defined within the surface and positioned on a first side of the rounded rod portion, and a third opening defined within the surface and positioned on a second side of the rounded rod portion opposite the first side of the rounded rod portion.

In accordance with this exemplary embodiment of the present invention, the cover piece may also include a first rounded lip on the surface surrounding at least a portion of the first opening.

In accordance with this exemplary embodiment of the present invention, the cover piece may also include a second rounded lip on the surface surrounding at least a portion of the second opening, and a third rounded lip on the surface surrounding at least a portion of the third opening.

In accordance with this exemplary embodiment of the present invention, the cover piece may also include a tab extending from the sidewall in a direction away from the interior region. The tab may include one or more holes.

It has also been found that the foregoing and related objects can be readily attained in a trash collecting device in accordance with another exemplary embodiment of the present invention, where the trash collecting device includes a cover piece that may include a sidewall defining an interior region of the cover piece, a surface extending from the sidewall towards the interior region, a handle connected to the surface, and a first opening within the surface. The trash collecting device may also include a retaining ring configured for removable attachment to the cover piece and dimensioned to fit in a nested engagement within the interior region of the cover piece. The handle may be positioned between the first opening and the sidewall, and the first opening may include at least one extension of the first opening defining an open channel in the surface extending from the first opening towards the handle.

In accordance with this exemplary embodiment of the present invention, the handle may also include a rounded rod portion, and the cover piece may also include a second opening defined within the surface and positioned on a first side of the rounded rod portion, and a third opening defined within the surface and positioned on a second side of the rounded rod portion opposite the first side of the rounded rod portion.

In accordance with this exemplary embodiment of the present invention, the rounded rod portion of the handle may be hollow.

In accordance with this exemplary embodiment of the present invention, the trash collecting device is configured to securely hold at least a portion of a bag between the retaining ring and the cover piece when the retaining ring is placed in the nested engagement within the interior region of the cover piece.

In accordance with this exemplary embodiment of the present invention, the retaining ring may include an inner surface, an outer surface, and a groove longitudinally defined at least over a portion of the outer surface.

In accordance with this exemplary embodiment of the present invention, the cover piece may include at least one protrusion extending from the sidewall towards the interior region, and the groove of the retaining ring is dimensioned for receipt of the at least one protrusion.

In accordance with this exemplary embodiment of the present invention, the groove and the at least one protrusion are configured to engage to securely hold at least a portion of the retaining ring within the interior region of the cover piece.

In accordance with this exemplary embodiment of the present invention, the cover piece may also include a first rounded lip on the surface surrounding at least a portion of the first opening.

In accordance with this exemplary embodiment of the present invention, the cover piece may also include a second rounded lip on the surface surrounding at least a portion of the second opening, and a third rounded lip on the surface surrounding at least a portion of the third opening.

In accordance with this exemplary embodiment of the present invention, the cover piece may also include a tab extending from the sidewall in a direction away from the interior region. The tab may have at least one hole formed therein.

In accordance with this exemplary embodiment of the present invention, the retaining may also include an extension dimensioned to extend from the cover piece when the retaining ring is placed in the nested engagement within the interior region of the cover piece.

In accordance with this exemplary embodiment of the present invention, the cover piece and the retaining ring are formed from a resilient material so as to be configured to produce a resilient clamping action on the bag. The resilient material may be comprised of a plastic resin or the like.

It has also been found that the foregoing and related objects can be readily attained in a method of collecting at least one piece of debris using a trash collecting device in accordance with another exemplary embodiment of the present invention, where the a trash collecting device includes a cover piece and a retaining ring, and the method inserting at least a portion of a bag having an opening between the cover piece and the retaining ring, engaging the cover piece with the retaining ring to form a nested engagement of the retaining ring within the cover piece. The nested engagement is configured to secure at least the portion of the bag to the trash collecting device and maintain the opening of the bag at least partially open, the cover piece may include a sidewall defining an interior region of the cover piece, a surface extending from the sidewall towards the interior region, a handle connected to the surface, and a first opening within the surface, the handle is positioned between the first opening and the sidewall, and the first opening may include at least one extension of the opening defining an open channel in the surface extending from the first opening towards the handle. The method may also include depositing the at least one piece of debris into the bag through the first opening.

In accordance with this exemplary embodiment of the present invention, the cover piece may also include a tab extending from the sidewall in a direction away from the interior region, and the method may also include releasing the cover piece from the retaining ring by urging the tab and the retaining ring in substantially opposite directions.

In accordance with this exemplary embodiment of the present invention, the cover piece may also include a tab extending from the sidewall in a direction away from the interior region, and the retaining ring may also include an extension dimensioned to extend from the cover piece when the retaining ring is placed in the nested engagement within the interior region of the cover piece, and the method may also include releasing the cover piece from the retaining ring by urging the tab and the extension in substantially opposite directions.

In accordance with this exemplary embodiment of the present invention, the cover piece further comprises a second opening defined within the surface and positioned on a first side of the handle, and a third opening defined within the surface and positioned on a second side of the handle opposite the first side of the rounded rod portion, and the method may also include manipulating a position of the trash collecting device through use of the handle.

### BRIEF DESCRIPTION OF THE DRAWINGS

Having thus described the invention in general terms, reference will now be made to the accompanying drawings, which are not necessarily drawn to scale, where:

FIG. 1 is a perspective view of a first exemplary trash collecting device installed on a trash bag in accordance with the present invention;

FIG. 2 is an exploded perspective view of the first exemplary trash collecting device in accordance with the present invention;

FIG. 3 is a top plan view of a first exemplary top cover piece of the first exemplary trash collecting device in accordance with the present invention;

FIG. 4 is a bottom plan view of the first exemplary top cover piece of the first exemplary trash collecting device in accordance with the present invention;

FIG. 5 is a front view of the first exemplary top cover piece of the first exemplary trash collecting device in accordance with the present invention;

FIG. 6 is a left side view of the first exemplary top cover piece of the first exemplary trash collecting device in accordance with the present invention;

FIG. 7 is a rear view of the first exemplary top cover piece of the first exemplary trash collecting device in accordance with the present invention;

FIG. 8 is a top plan view of a first exemplary bottom retaining ring of the first exemplary trash collecting device in accordance with the present invention;

FIG. 9 is a side view of the first exemplary bottom retaining ring of the first exemplary trash collecting device in accordance with the present invention;

FIG. 10 is a cross-sectional view taken along line 10-10 in FIG. 3 of the first exemplary top cover piece of the first exemplary trash collecting device in accordance with the present invention;

FIG. 11 is a cross-sectional view taken along line 11-11 in FIG. 4 of the first exemplary bottom retaining ring of the first exemplary trash collecting device in accordance with the present invention;

FIG. 12 is an exploded cross-sectional view showing how a trash bag is placed between the first exemplary top cover piece and the first exemplary bottom retaining ring of the first exemplary trash collecting device in accordance with the present invention;

FIG. 13 is a cross-sectional view showing how a trash bag is held between the first exemplary top cover piece and the first exemplary bottom retaining ring of the first exemplary trash collecting device in accordance with the present invention;

FIG. 14 is a perspective view of a second exemplary trash collecting device installed on a trash bag in accordance with the present invention;

FIG. 15 is an exploded perspective view of the second exemplary trash collecting device in accordance with the present invention;

FIG. 16 is a top plan view of a second exemplary top cover piece of the second exemplary trash collecting device in accordance with the present invention;

FIG. 17 is a bottom plan view of the second exemplary top cover piece of the second exemplary trash collecting device in accordance with the present invention;

FIG. 18 is a front view of the second exemplary top cover piece of the second exemplary trash collecting device in accordance with the present invention;

FIG. 19 is a left side view of the second exemplary top cover piece of the second exemplary trash collecting device in accordance with the present invention;

FIG. 20 is a rear view of the second exemplary top cover piece of the second exemplary trash collecting device in accordance with the present invention;

FIG. 21 is a top plan view of a second exemplary bottom retaining ring of the second exemplary trash collecting device in accordance with the present invention;

FIG. 22 is a bottom plan view of the second exemplary bottom retaining ring of the second exemplary trash collecting device in accordance with the present invention;

FIG. 23 is a front view of the second exemplary bottom retaining ring of the second exemplary trash collecting device in accordance with the present invention;

FIG. 24 is a left side view of the second exemplary bottom retaining ring of the second exemplary trash collecting device in accordance with the present invention;

FIG. 25 is a rear view of the second exemplary bottom retaining ring of the second exemplary trash collecting device in accordance with the present invention;

FIG. 26 is a perspective view of the second exemplary trash collecting device in accordance with the present invention;

FIG. 27 is a bottom plan view of the second exemplary trash collecting device in accordance with the present invention;

FIG. 28 is a cross-sectional view taken along line 28-28 in FIG. 16 of the second exemplary top cover piece of the second exemplary trash collecting device in accordance with the present invention;

FIG. 29 is a cross-sectional view taken along line 29-29 in FIG. 21 of the second exemplary bottom retaining ring of the second exemplary trash collecting device in accordance with the present invention;

FIG. 30 is an exploded cross-sectional view showing how a trash bag is placed between the second exemplary top cover piece and the second exemplary bottom retaining ring of the second exemplary trash collecting device in accordance with the present invention; and

FIG. 31 is a cross-sectional view showing how a trash bag is held between the second exemplary top cover piece and the second exemplary bottom retaining ring of the second exemplary trash collecting device in accordance with the present invention.

### DETAILED DESCRIPTION OF THE INVENTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

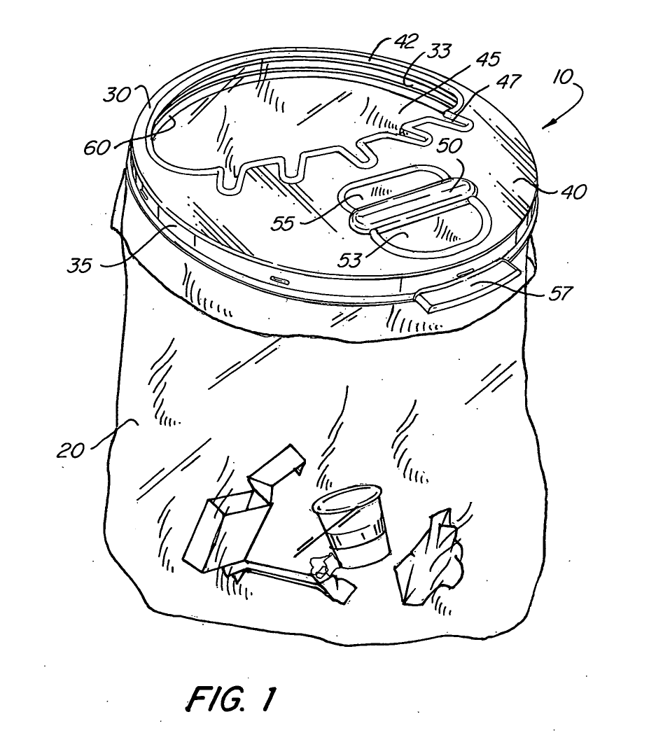

Referring first to FIG. 1, therein illustrated is a first exemplary embodiment of a trash collecting device generally indicated by the numeral 10 of the present invention with a trash bag 20 installed thereon. The trash collecting device 10 is designed to keep a mouth of the trash bag 20 permanently open during use to assist a user of the trash colleting device 10 in depositing debris and trash into the trash bag 20. With safety in mind the trash collecting device 10 with the trash bag 20 attached is designed to assist the user in collecting debris and trash in a more effective and efficient manner. Since the trash collecting device 10 may be easy to handle, using of the trash collecting device 10 to keep the mouth of the trash bag 20 open will also enable the user to be more productive. Therefore, the trash collecting device 10 will prove itself to be cost effective for employers as it is durable and will provide a quicker way for workers of the employers to perform their debris and trash collecting duties.

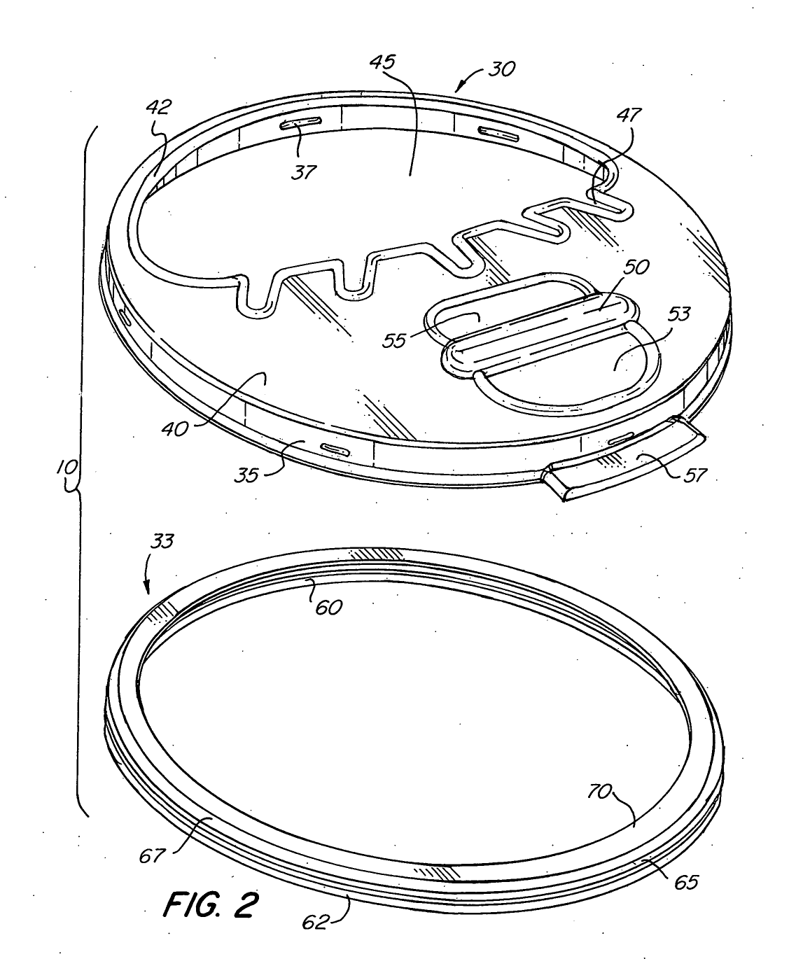

Referring now to FIG. 2, the structure of the trash collecting device 10 is shown in greater detail. The trash collecting device 10 has a substantially circular configuration and includes a top cover piece generally indicated by the numeral 30, and a bottom retaining ring generally indicated by the numeral 33.

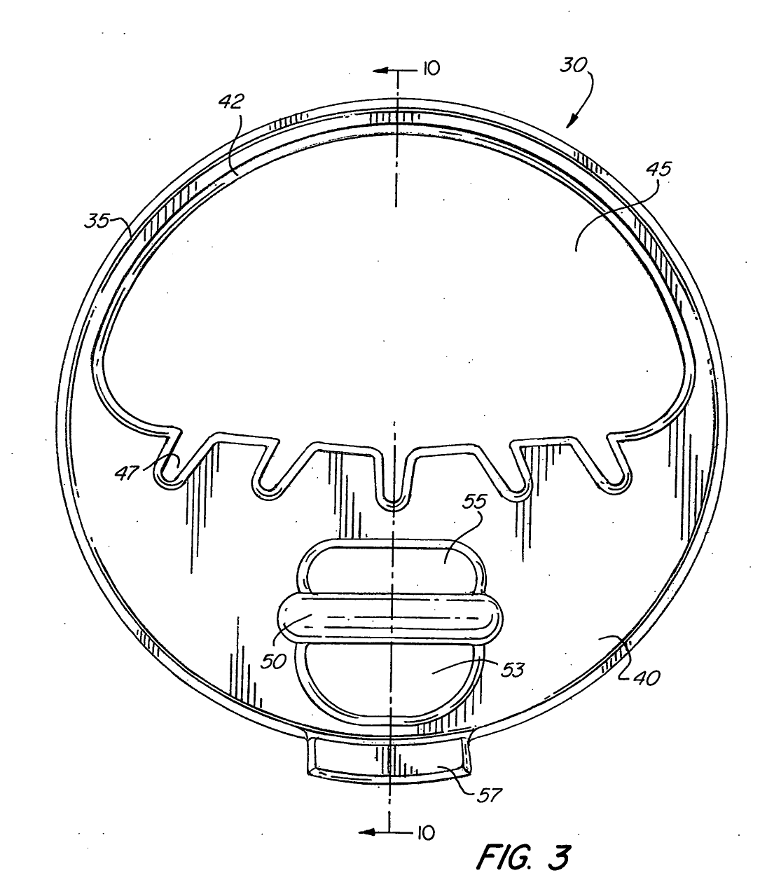

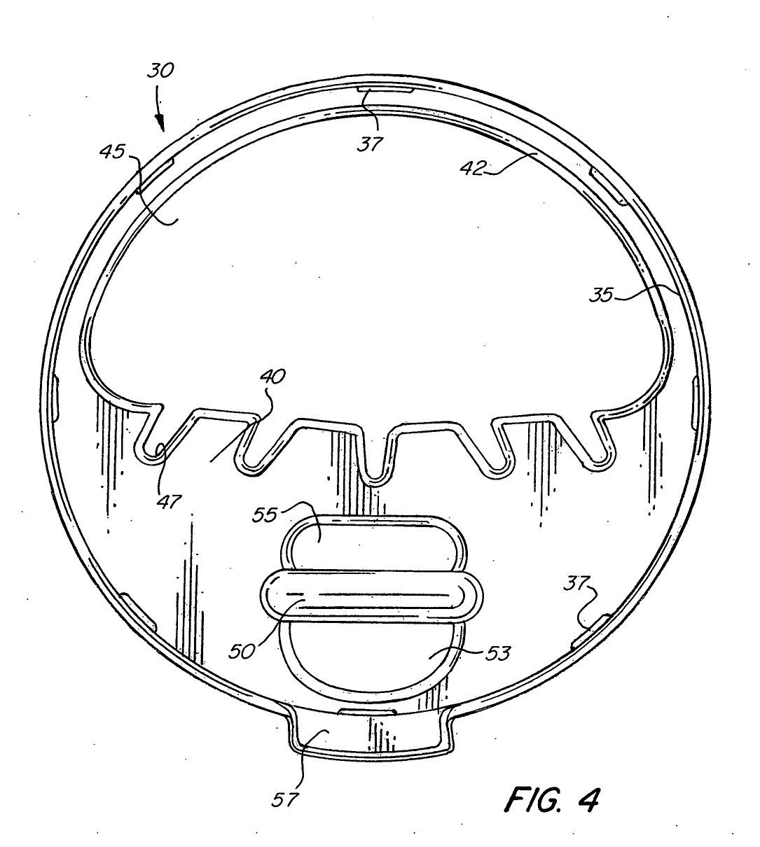

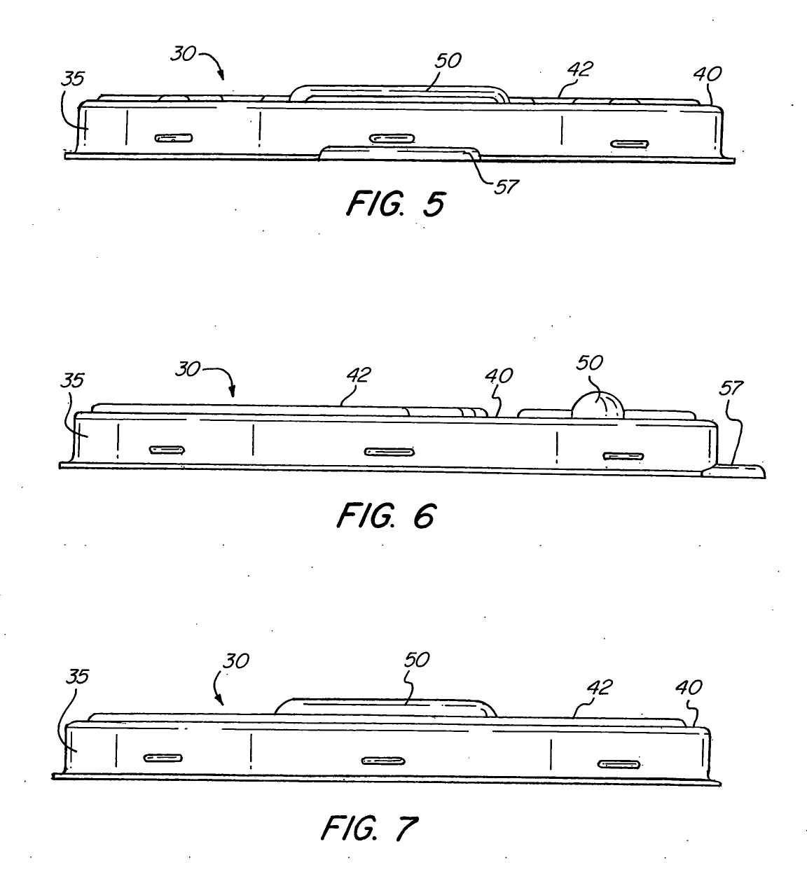

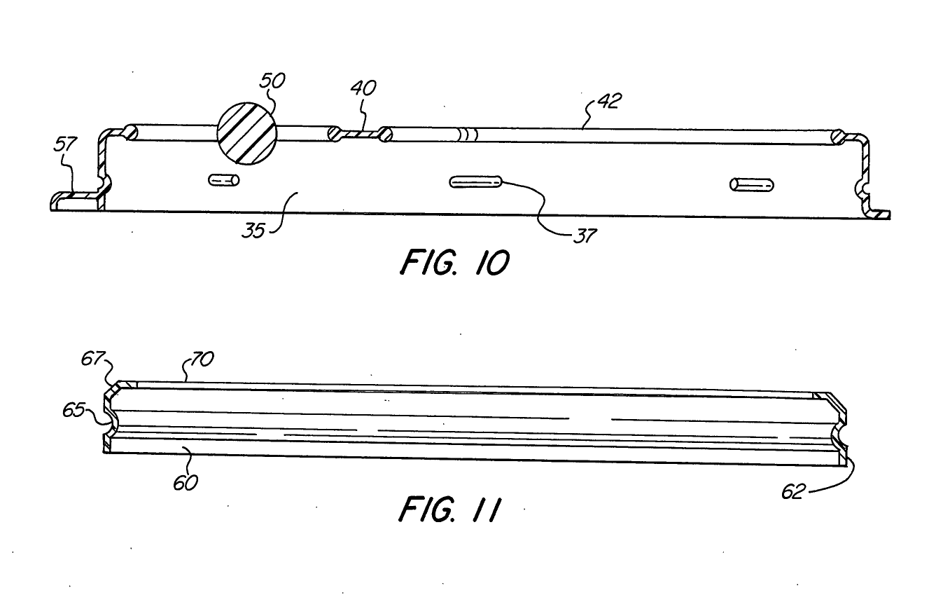

As shown in FIGS. 3-7 and 10, the top cover piece 30 of the trash collecting device 10 may include a substantially circular side wall 35 and one or more protrusions 37 on a surface of the substantially circular side wall 35 facing an interior region of the top cover piece 30. Spanning the interior of the substantially circular side wall 35 is a smooth planar surface 40 extending from the substantially circular side wall 35 towards the interior region of the top cover piece 30. On the smooth planar surface 40 there is provided a protruding lip 42 defining a semi-circular opening 45 in the smooth planar surface 40 of the top cover piece 30. The protruding lip 42 may be configured to define one or more finger-shaped, diverging channels 47 extending from an interior portion of the semi-circular opening 45. The finger-shaped, diverging channels 47 may be dimensioned and positioned with respect to the semi-circular opening 45 so that a paper picker (not shown) can be swiped on one of the finger-shaped, diverging channels 47 in order to deposit debris and/or trash through the semi-circular opening 45 into the trash bag 20 installed on the trash collecting device 10. The one or more finger-shaped, diverging channels 47 may be positioned for use by either right or left handed users. Also in the top cover piece 30 is a manually engageable handle 50 for manipulating the trash collecting device 10 when in use. The manually engageable handle 50 is positioned within the smooth planar surface 40 and between the semi-circular opening 45 and the substantially circular side wall 35. The one or more finger-shaped, diverging channels 47 are positioned between the semi-circular opening 45 and the manually engageable handle 50. A thumb opening 53 and a finger opening 55 are defined within the smooth planar surface 40 adjacent to the manually engageable handle 50 in order to allow a user to extend the user's fingers and thumb around the manually engageable handle 50. The thumb opening 53 is positioned between the manually engageable handle 50 and the substantially circular side wall 35 on the side of the manually engageable handle that is opposite the semi-circular opening 45, and the finger opening 55 is positioned between the manually engageable handle 50 and the semi-circular opening 45. The manually engageable handle 50 may be designed for use by either right-handed or left-handed users. The top cover piece 30 may also include a tab 57 extending from the substantially circular side wall 35 on an exterior surface of the top cover piece 30. The tab 57 may be configured to facilitate separating the top cover piece 30 from the bottom retaining ring 33 in a manner described further hereinafter.

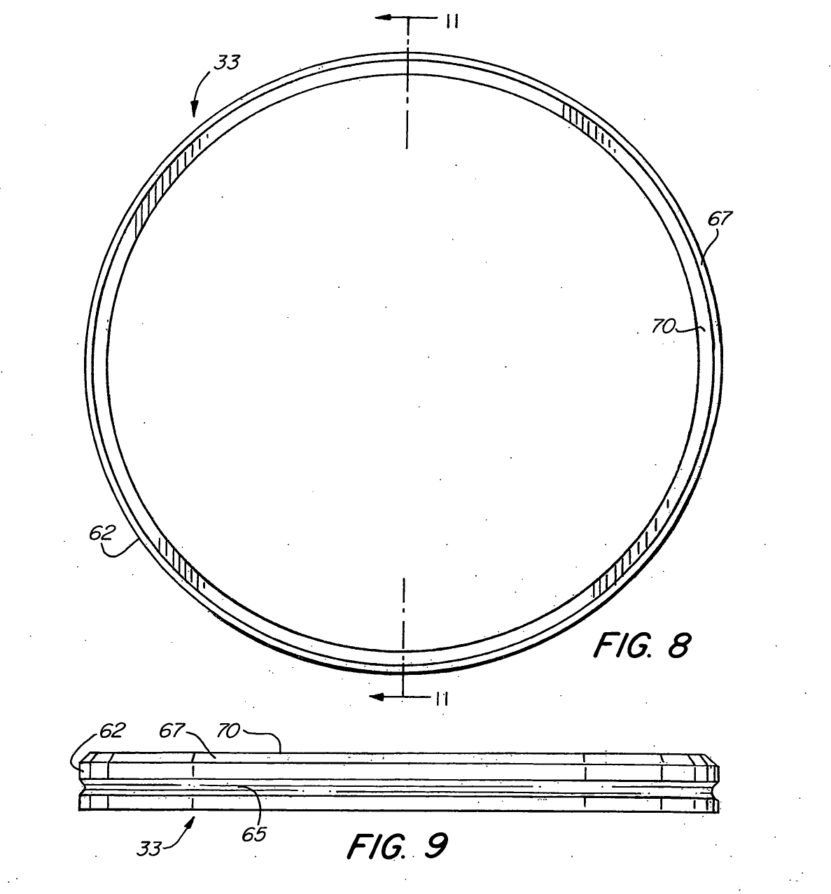

Referring now to FIGS. 8, 9 and 11, which show the bottom retaining ring 33 of the trash collecting device 10. The bottom retaining ring 33 may include an inside rim 60 facing the interior region of the bottom retaining ring 33, and an outer edge 62. The outer edge 62 may include a groove 65 extending around the periphery of the bottom retaining ring 33. The bottom retaining ring 33 may have an angled surface 67 extending therefrom in a direction towards the interior region of the bottom retaining ring 33. The bottom retaining ring 33 may also include an inwardly extending circumferential lip 70 extending from the angled surface 67 and positioned substantially perpendicular to the inside rim 60 and outer edge 62 of the bottom retaining ring 33.

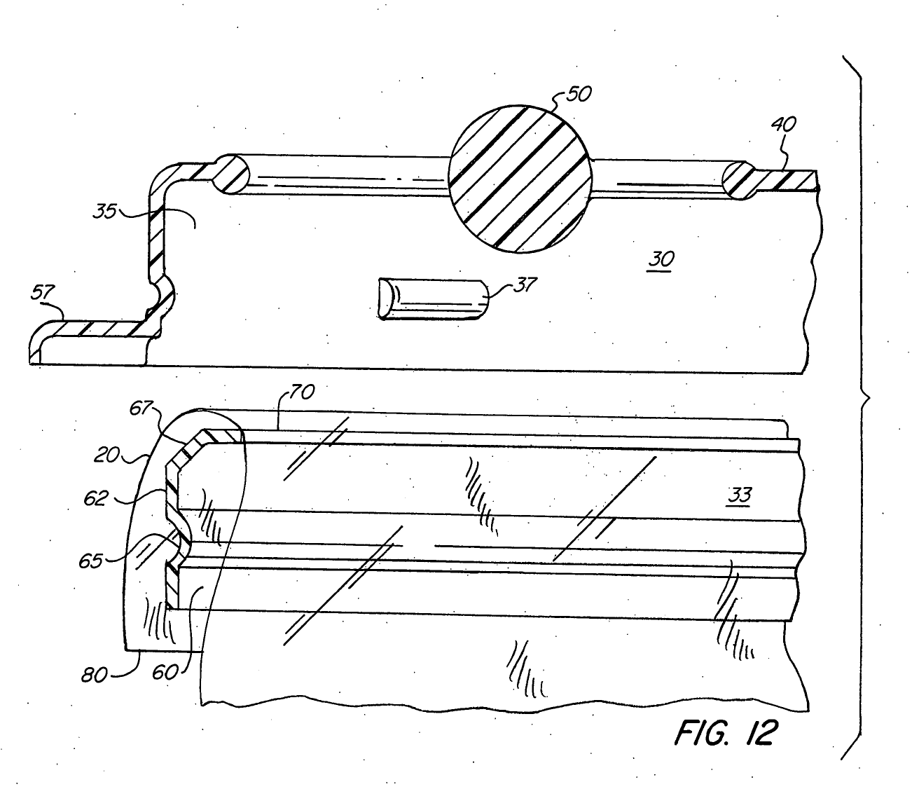

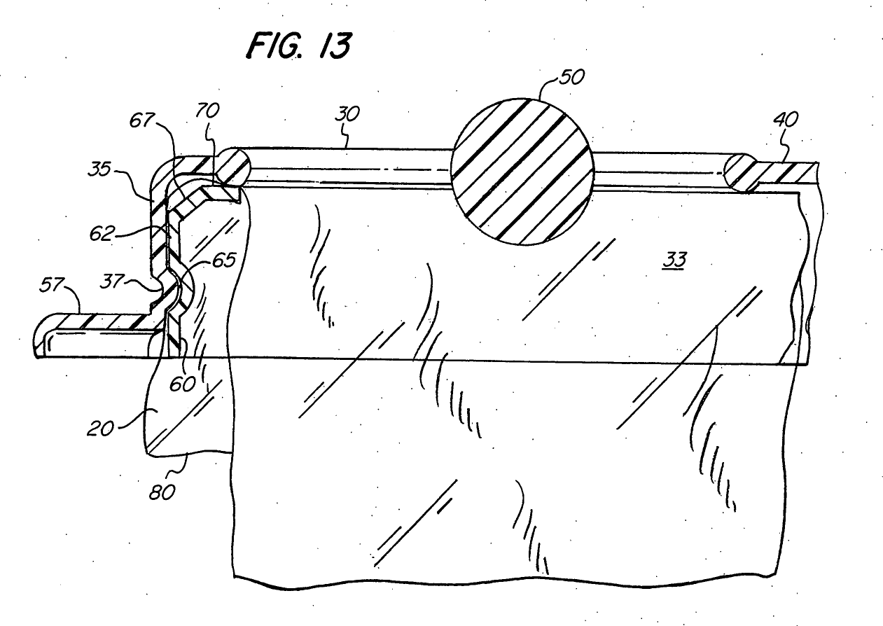

Turning to FIGS. 12 and 13, the cooperation of the top cover piece 30 and bottom retaining ring 33 in retaining the trash bag 20 on the trash collecting device 10 will be more clearly understood. As shown in FIG. 12, to install the trash bag 20 on the trash collecting device 10, an upper edge 80 defining an opening (not shown) of the trash bag 20 is inserted from under the inside rim 60 of the bottom retaining ring 33 and then draped over the outer edge 62 of the bottom retaining ring 33. The user then snaps the bottom retaining ring 33 with the upper edge of the trash bag 20 draped there over into the top cover piece 30 from the bottom of the top cover piece 30 to form a nested engagement of the bottom retaining ring 33 within the top cover piece 30. The one or more protrusions 37 on the interior of the substantially circular side wall 35 of the top cover piece 30 operationally engage with the groove 65 formed in the outer edge 62 of the bottom retaining ring 33 in order to hold the top cover piece 30 and bottom retaining ring 33 together with the trash bag 20 trapped therebetween. The trash bag 20 is thereby securely held in between the top cover piece 30 and bottom retaining ring 33. The top cover piece 30 may be removed from the bottom retaining ring 33, and the trash bag 20 removed from the trash collecting device 10 by disengaging the one or more protrusions 37 from the groove 65. The tab 57 on the top cover piece 30 may be used to facilitate disengaging the one or more protrusions 37 from the groove 65.

In use, a user of the trash collecting device 10 with trash bag 20 securely held thereon grasps the manually engageable handle 50 by inserting his or her fingers through the finger opening 55 and his or her thumb through the thumb opening 53 adjacent to the manually engageable handle 50, and wrapping his or her fingers and thumb around the manually engageable handle 50. The user may use either his or her right or left hand to grasp the manually engageable handle 50 depending upon the preference of the user. It is understood that the user may hold the manually engageable handle 50 with the palm of the user's hand either face-up or face-down depending upon the preference of the user. The user then holds the trash collecting device 10 upright with the trash collecting device 10 positioned substantially parallel with a ground surface from which the user intends to collect trash and debris from. It is understood that the orientation of the trash collecting device 10 relative to the ground surface is merely exemplary, and that the trash collecting device 10 is operational in a variety of orientations, such as perpendicular relative to the ground surface or at any other angle relative to the ground surface.

The user may then pick up a piece of trash or debris either with the user's hand that is not holding the manually engageable handle 50 or with the use of a paper picker or other grabbing device, and then deposit the piece of trash or debris through the opening 45 into the trash bag 20 securely held on the trash collecting device 10. If a paper picker is used, the user can use the one or more finger-shaped, diverging channels 47 to remove the piece of garbage or debris from the paper picker by positioning the piece of garbage or debris on the paper picker below the smooth planar surface 40 surrounding the one or more finger-shaped, diverging channels 47, and pulling the paper picker away from the trash collecting device 10 in order to urge the piece of garbage or debris off of the paper picker and into the trash bag 20 securely held on the trash collecting device 10. It is understood that the thumb opening 53 and finger opening 55 adjacent to the manually engageable handle 50 are dimensioned so that the user can rotate his or her hand about the manually engageable handle 50 without the smooth planar surface 40 substantially interfering with the user's operation of the trash collecting device 10. It is also understood, that the trash collecting device 10 may also be held substantially perpendicular and adjacent to the ground so that the user can scoop trash or debris through the semi-circular opening 45 into the trash bag 20 securely held on the trash collecting device 10.

The top cover piece 30 and bottom retaining ring 33 of the trash collecting device 10 are preferably molded from a plastic resin such as, recycled acrylonitrile butadiene styrene (ABS) plastic, polystyrene or the like, but it should be apparent to those skilled in the art that they may be manufactured from other suitable materials. It may be preferable that the material used to form the top cover piece 30 and the bottom retaining ring 33 be durable and resilient. The material may be slightly resilient, in which case, the top cover piece 30 and the bottom retaining ring 33 will exhibit a resilient clamping action on the trash bag 20. The top cover piece 30 and bottom retaining ring 33 may be made in any color, for example, fluorescent orange, green or yellow. It is understood that many different bags designed for a variety of uses and from a variety of suppliers can be attached to the trash collecting device 10 and that the discussions regarding trash bags are merely exemplary. It is also understood that the trash collecting device 10 can be dimensioned to accommodate bags of different sizes and a variety of uses, including but not limited to, standard size trash and debris bags. It is further understood that the trash collecting device 10 enables the user to handle the debris and trash picking in a more sanitary situation.

Thus, it can be seen from the foregoing discussion that the device of the present invention facilitates the use of a conventional thin plastic trash bag by holding it open so trash can be inserted therein. The positioning of the manually engageable handle 50 towards the center of the device provides stability to the device when held by the user.

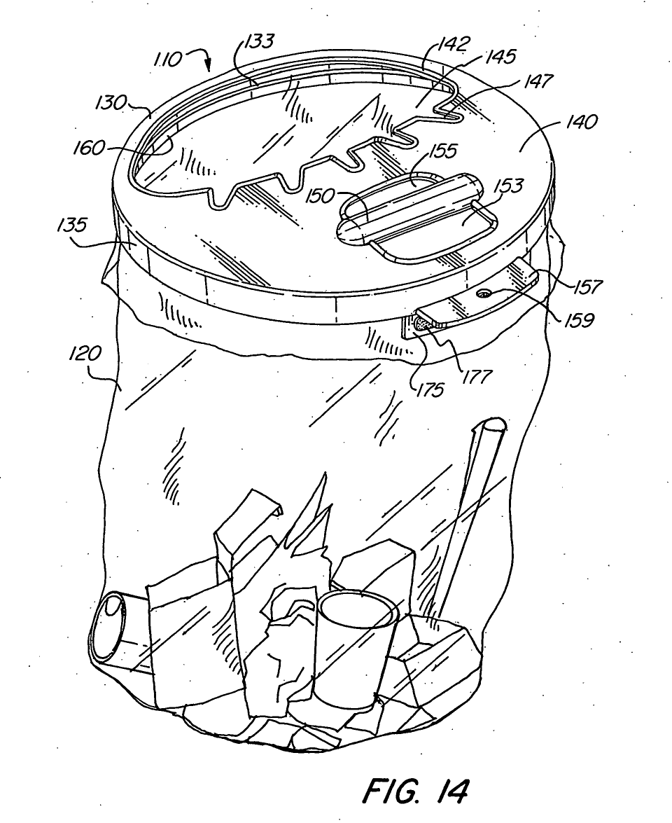

Referring to now FIG. 14, therein illustrated is a second exemplary trash collecting device generally indicated by the numeral 110 of the present invention with a trash bag 120 installed thereon. Features of the second exemplary embodiment of the invention that correspond to similar features of the first exemplary embodiment of the invention are identified by a reference numeral increased by 100 from the reference numeral used to identify the similar feature of the first exemplary embodiment. The trash collecting device 110 is designed to keep a mouth of the trash bag 120 permanently open during use to assist a user of the trash colleting device 110 in depositing debris and trash into the trash bag 120. With safety in mind, the trash collecting device 110 with the trash bag 120 attached is designed to assist the user in collecting debris and trash in a more effective and efficient manner. Since the trash collecting device 110 may be easy to handle, using of the trash collecting device 110 to keep the mouth of the trash bag 120 open will also enable the user to be more productive. Therefore, the trash collecting device 110 will prove itself to be cost effective for employers as it is durable and will provide a quicker way for workers of the employers to perform their debris and trash collecting duties.

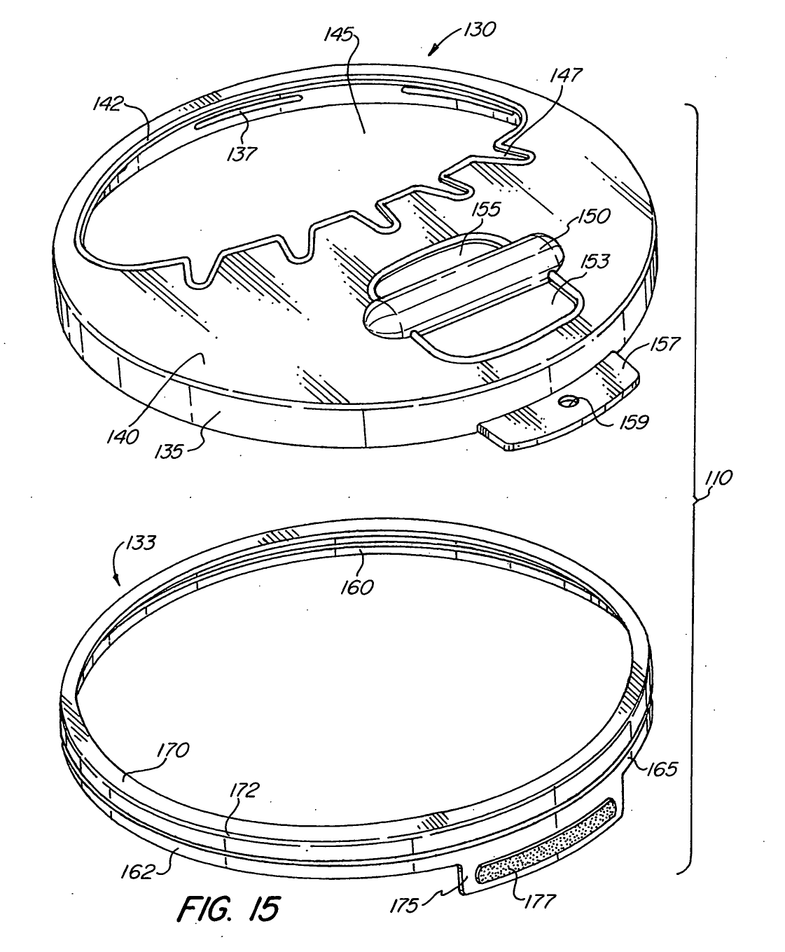

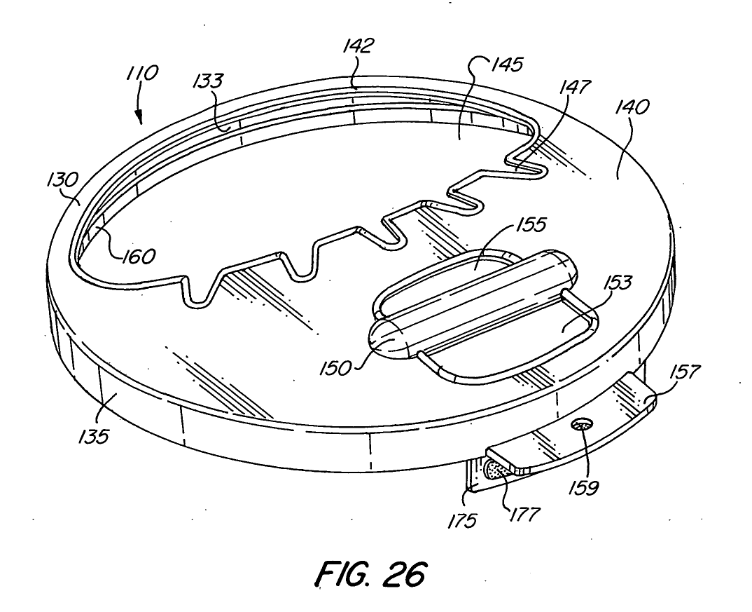

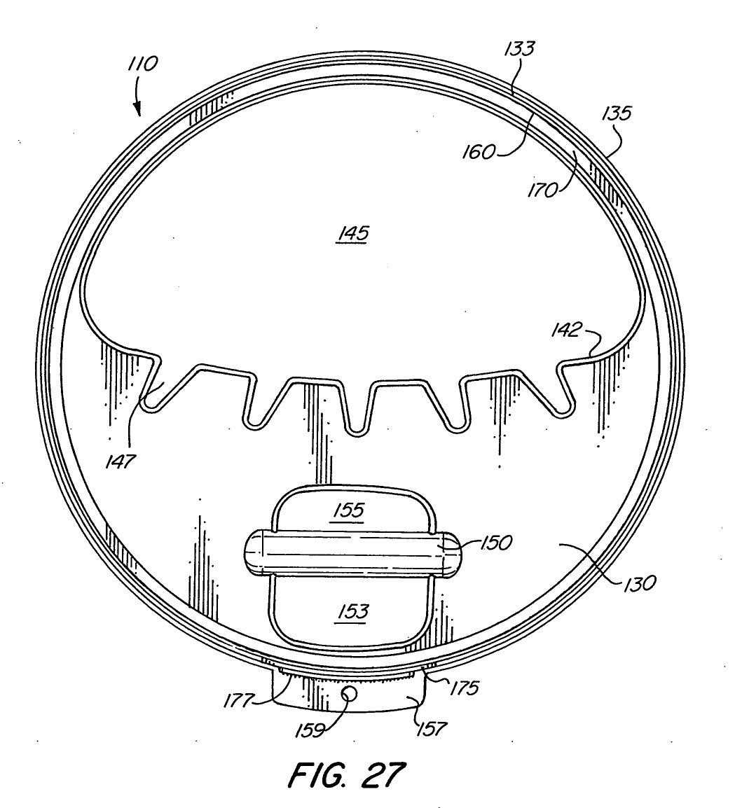

Referring now to FIG. 15, the structure of the trash collecting device 110 is shown in greater detail. The trash collecting device 110 has a substantially circular configuration and includes a top cover piece generally indicated by the numeral 130, and a bottom retaining ring generally indicated by the numeral 133. As shown in FIGS. 26 and 27 the bottom retaining ring 133 may be secured within the top cover piece 130 in order to form a nested engagement of the bottom retaining ring 133 and top cover piece 130 of the trash collecting device 110.

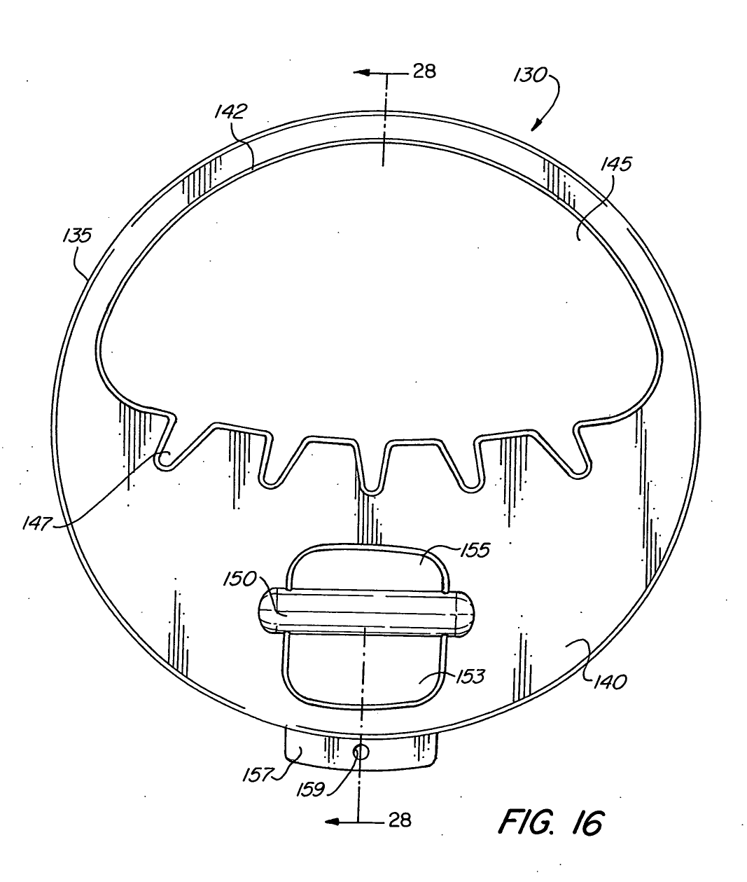

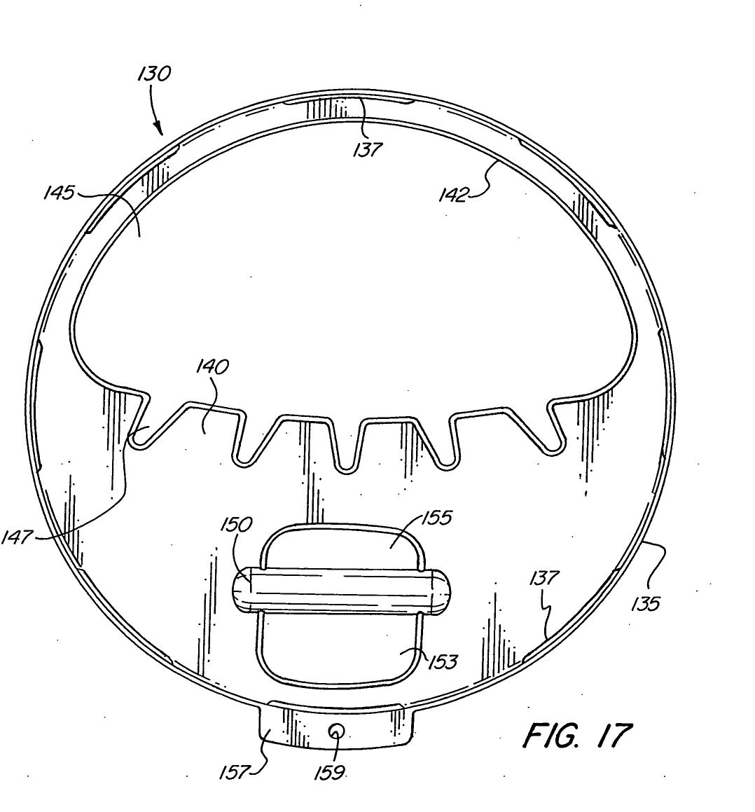

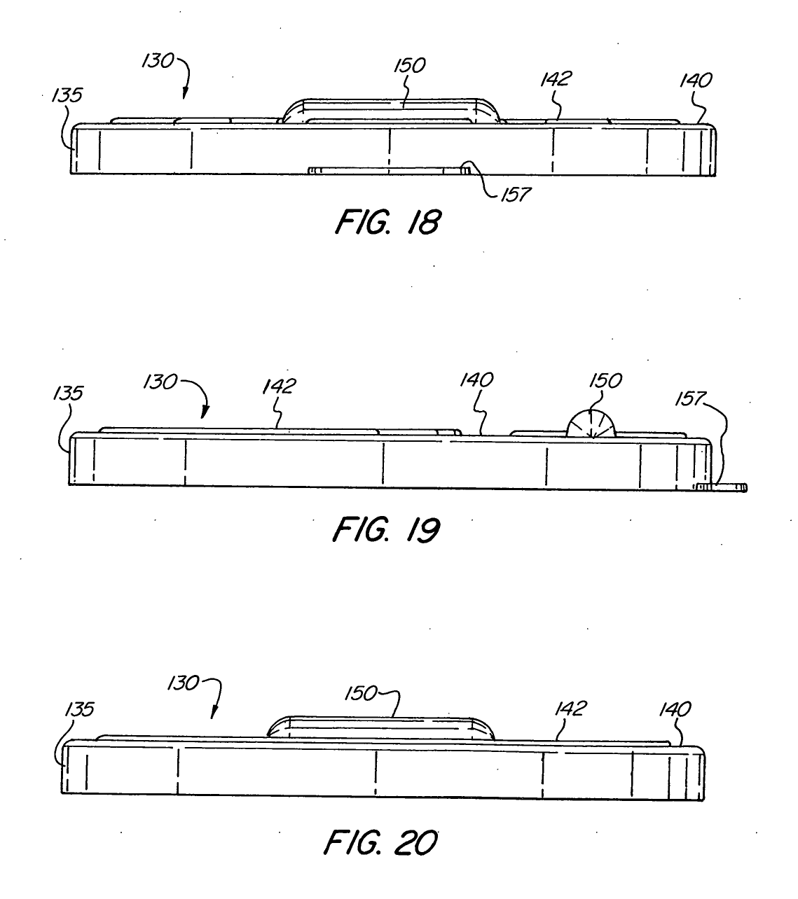

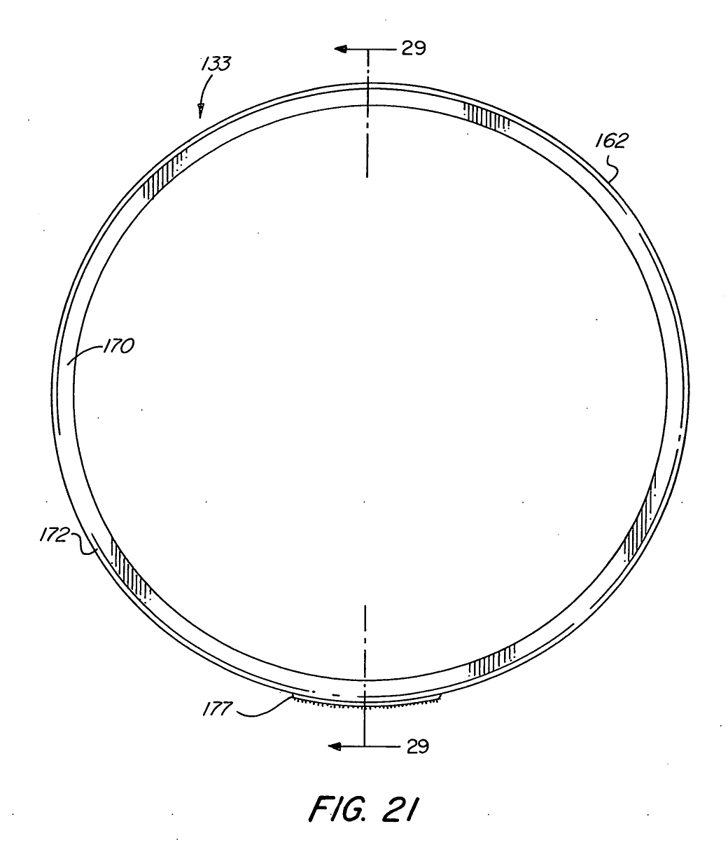

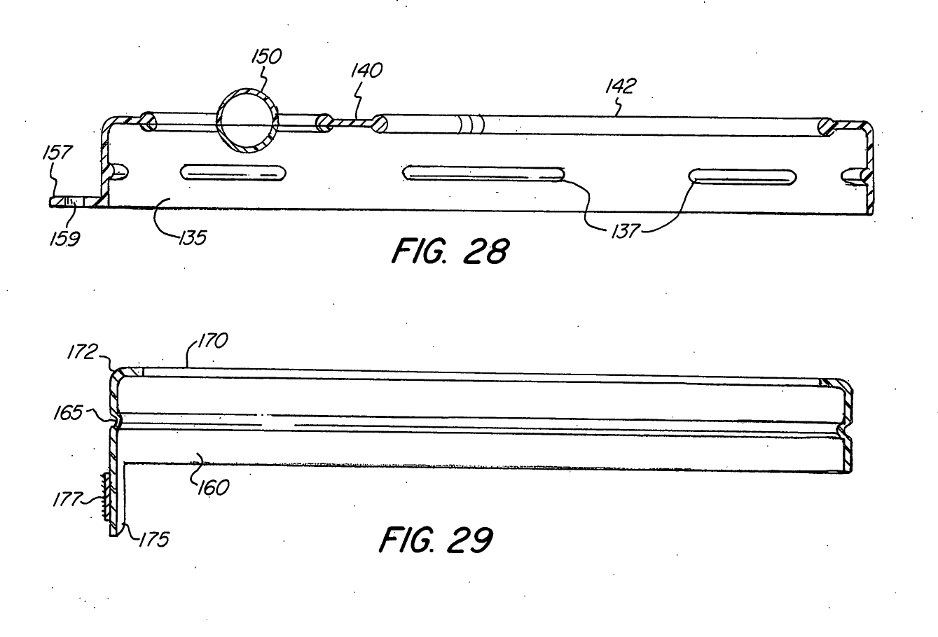

As shown in FIGS. 16-20 and 28, the top cover piece 130 of the trash collecting device 110 may include a substantially circular side wall 135 and one or more protrusions 137 on a surface of the substantially circular side wall 135 facing an interior region of the top cover piece 130. Spanning the interior of the substantially circular side wall 135 is a smooth planar surface 140 extending from the substantially circular side wall 135 towards the interior region of the top cover piece 130. On the smooth planar surface 140 there is provided a protruding lip 142 defining a semi-circular opening 145 in the smooth planar surface 140 of the top cover piece 130. The protruding lip 142 may be configured to define one or more finger-shaped, diverging channels 147 extending from an interior portion of the semi-circular opening 145. The finger-shaped, diverging channels 147 may be dimensioned and positioned with respect to the semi-circular opening 145 so that a paper picker (not shown) can be swiped on one of the finger-shaped, diverging channels 147 in order to deposit debris and/or trash through the semi-circular opening 145 into the trash bag 120 installed on the trash collecting device 110. The one or more finger-shaped, diverging channels 147 may be positioned for use by either right or left handed users. Also in the top cover piece 130 is a manually engageable handle 150 for manipulating the trash collecting device 110 when in use. The manually engageable handle 150 is positioned within the smooth planar surface 140 and between the semi-circular opening 145 and the substantially circular side wall 135. The one or more finger-shaped, diverging channels 147 are positioned between the semi-circular opening 145 and the manually engageable handle 150. A thumb opening 153 and a finger opening 155 are defined within the smooth planar surface 140 adjacent to the manually engageable handle 150 in order to allow a user to extend the user's fingers and thumb around the manually engageable handle 150. The thumb opening 153 is positioned between the manually engageable handle 150 and the substantially circular side wall 135 on the side of the manually engageable handle that is opposite the semi-circular opening 145, and the finger opening 155 is positioned between the manually engageable handle 150 and the semi-circular opening 145. The manually engageable handle 150 may be designed for use by either right-handed or left-handed users. The top cover piece 130 may also include a tab 157 extending from the substantially circular side wall 135 on an exterior surface of the top cover piece 130. The tab 157 may be configured to facilitate separating the top cover piece 130 from the bottom retaining ring 133 in a manner described further hereinafter. The tab 157 may include one or more holes 159 formed therein that may be used to removably secure the trash collecting device 110 to hooks, hangers or other retaining devices for storage. The one or more holes 159 may also be used to secure a leash or other tether (not shown) to the trash collecting device 110 for use by a user of the trash collecting device 110.

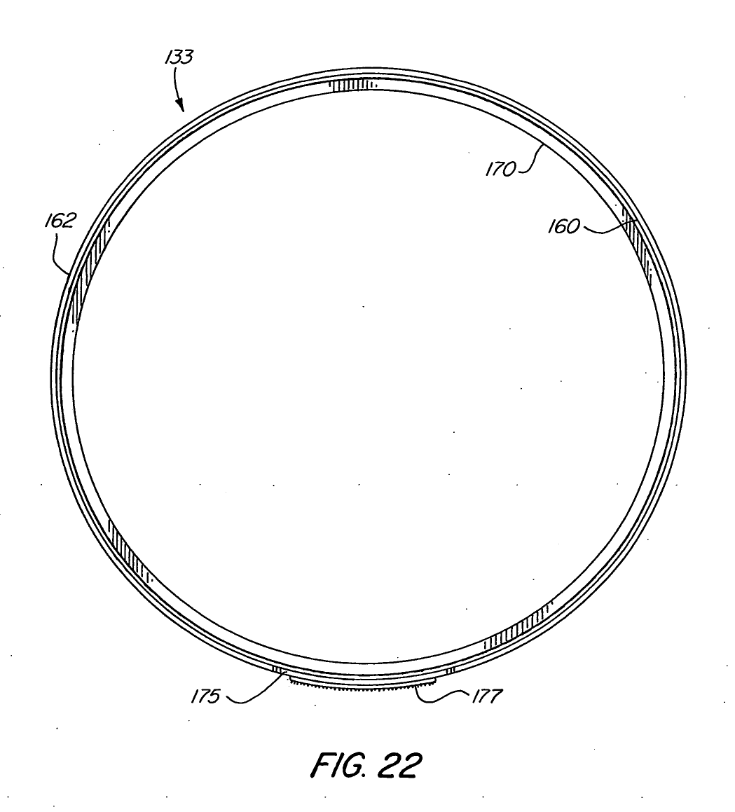

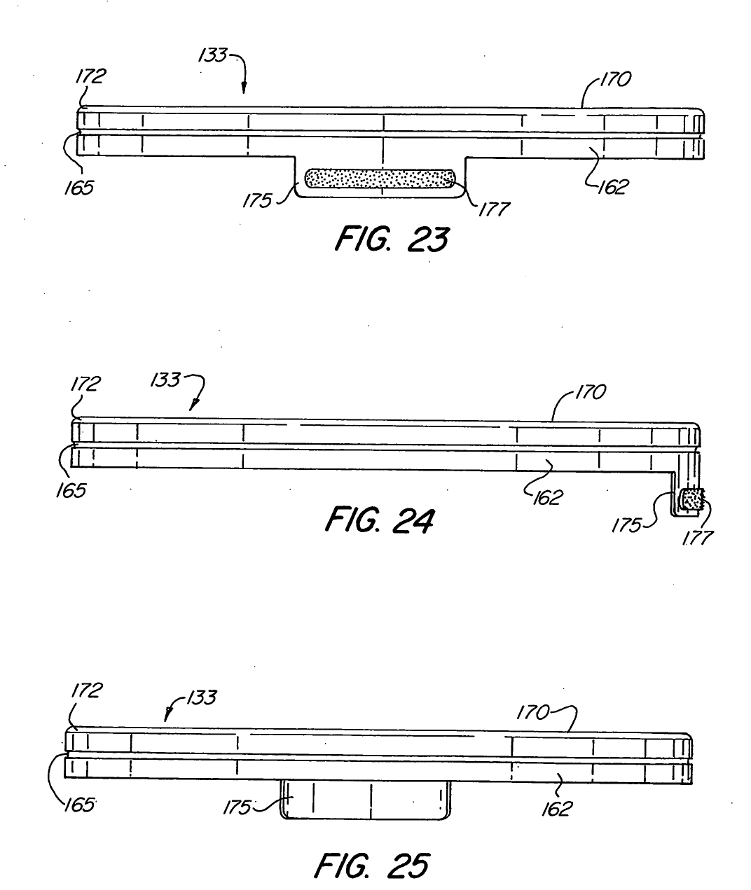

Referring now to FIGS. 21-25 and 29, which show the bottom retaining ring 133 of the trash collecting device 110. The bottom retaining ring 133 may include an inside rim 160 facing the interior region of the bottom retaining ring 133, and an outer edge 162. The outer edge 162 may include a groove 165 extending around the periphery of the bottom retaining ring 133. The bottom retaining ring 133 may also include an inwardly extending circumferential lip 170 positioned substantially perpendicular to the inside rim 160 and outer edge 162 of the bottom retaining ring 133. A rounded edge 172 may be formed on the bottom retaining ring 133 at the junction of the inwardly extending circumferential lip 170 and the outer edge 162. The bottom retaining ring 133 may also include an arched handle 175 extending therefrom, and following at least a portion of the circumference of the bottom retaining ring 133. The arched handle 175 is positioned on a side of the bottom retaining ring 133 opposite the inwardly extending circumferential lip 170. The arched handle 175 may include a frictional surface 177 formed thereon or affixed thereto.

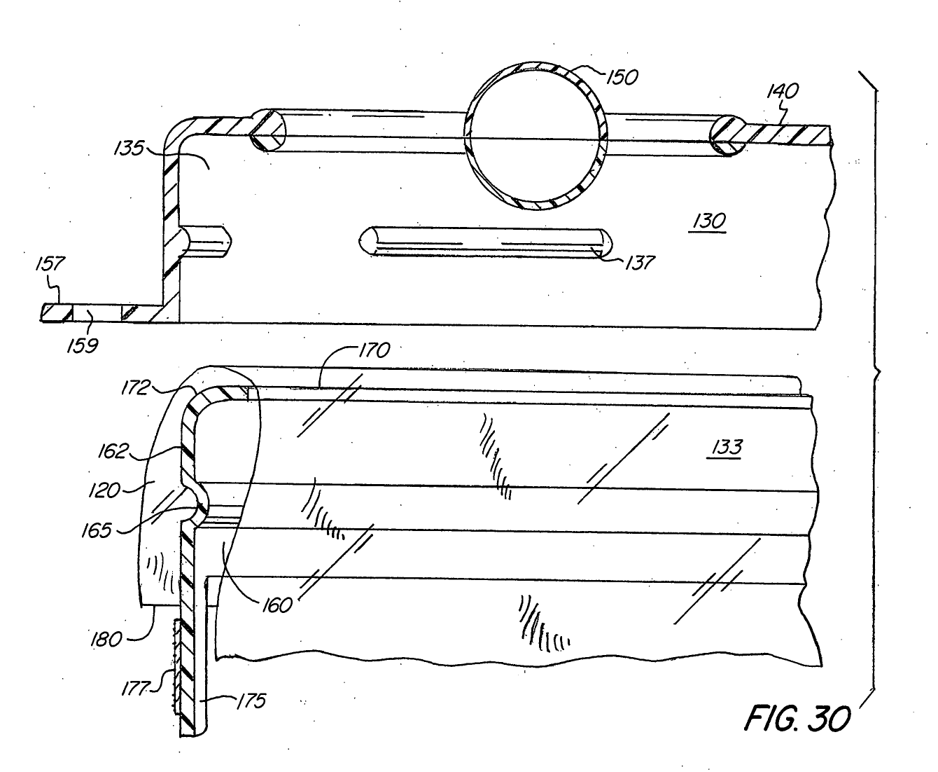

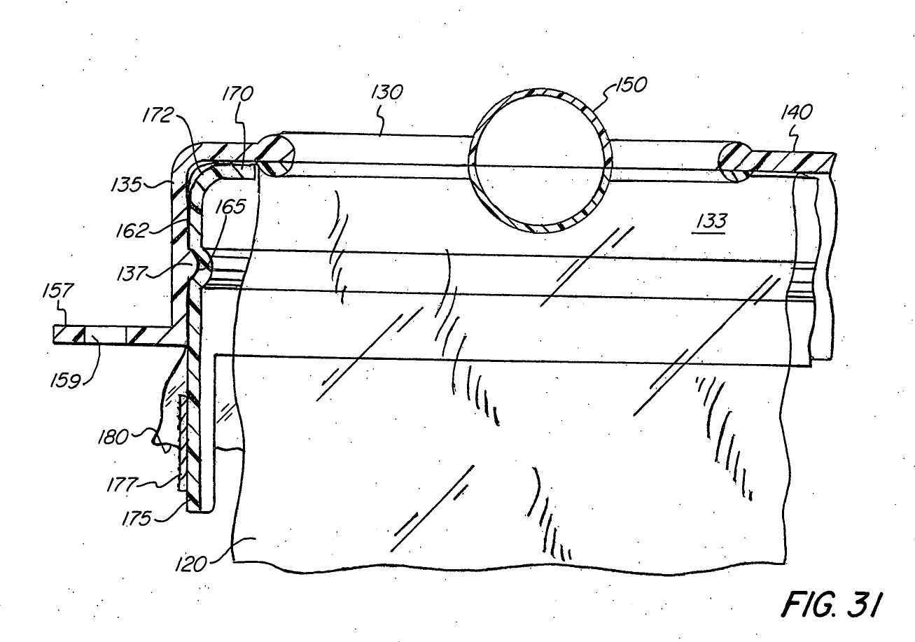

Turning to FIGS. 30 and 31, the cooperation of the top cover piece 130 and bottom retaining ring 133 in retaining the trash bag 120 on the trash collecting device 110 will be more clearly understood. As shown in FIG. 30, to install the trash bag 120 on the trash collecting device 110, an upper edge 180 defining an opening (not shown) of the trash bag 120 is inserted from under the inside rim 160 of the bottom retaining ring 133 and then draped over the outer edge 162 of the bottom retaining ring 133. The user then snaps the bottom retaining ring 133, with the upper edge of the trash bag 120 draped there over, into the top cover piece 130 from the bottom of the top cover piece 130 to form a nested arrangement of the bottom retaining ring 133 within the top cover piece 130. The one or more protrusions 137 on the interior of the substantially circular side wall 135 of the top cover piece 130 operationally engage with the groove 165 formed in the outer edge 162 of the bottom retaining ring 133 in order to hold the top cover piece 130 and bottom retaining ring 133 together with the trash bag 120 trapped therebetween. The trash bag 120 is thereby securely held in between the top cover piece 130 and bottom retaining ring 133. The top cover piece 130 may be removed from the bottom retaining ring 133, and the trash bag 120 removed from the trash collecting device 110 by disengaging the one or more protrusions 137 from the groove 165. The tab 157 on the top cover piece 130 and the arched handle 175 on the bottom retaining ring 133 may be used alone or in cooperation to facilitate disengaging the one or more protrusions 137 from the groove 165. In order to facilitate disengaging the one or more protrusions 137 from the groove 165, and thereby release the bottom retaining ring 133 from the top cover piece 130, the tab 157 may be held substantially in place while the arched handle 175 is urged in a direction substantially away from the tab 157, for example towards the interior region of the bottom retaining ring 133. The bottom retaining ring 133 and top cover piece 130 may be formed so as to sufficiently flex as a result of such actions so that the one or more protrusions 137 sufficiently disengage from the groove 165 to allow removal of the bottom retaining ring 133 from the top cover piece 130.

In use, a user of the trash collecting device 110 with trash bag 120 securely held thereon grasps the manually engageable handle 150 by inserting his or her fingers through the finger opening 155 and his or her thumb through the thumb opening 153 adjacent to the manually engageable handle 150, and wrapping his or her fingers and thumb around the manually engageable handle 150. The user may use either his or her right or left hand to grasp the manually engageable handle 150 depending upon the preference of the user. It is understood that the user may hold the manually engageable handle 150 with the palm of the user's hand either face-up or face-down depending upon the preference of the user. The user then holds the trash collecting device 110 upright with the trash collecting device 110 positioned substantially parallel with a ground surface from which the user intends to collect trash and debris from. It is understood that the orientation of the trash collecting device 110 relative to the ground surface is merely exemplary, and that the trash collecting device 110 is operational in a variety of orientations, such as perpendicular relative to the ground surface or at any other angle relative to the ground surface.

The user may then pick up a piece of trash or debris either with the user's hand that is not holding the manually engageable handle 150 or with the use of a paper picker or other grabbing device, and then deposit the piece of trash or debris through the opening 145 into the trash bag 120 securely held on the trash collecting device 110. If a paper picker is used, the user can use the one or more finger-shaped, diverging channels 147 to remove the piece of garbage or debris from the paper picker by positioning the piece of garbage or debris on the paper picker below the smooth planar surface 140 surrounding the one or more finger-shaped, diverging channels 147, and pulling the paper picker away from the trash collecting device 110 in order to urge the piece of garbage or debris off of the paper picker and into the trash bag 120 securely held on the trash collecting device 110. It is understood that the thumb opening 153 and finger opening 155 adjacent to the manually engageable handle 150 are dimensioned so that the user can rotate his or her hand about the manually engageable handle 150 without the smooth planar surface 140 substantially interfering with the user's operation of the trash collecting device 110. It is also understood, that the trash collecting device 110 may also be held substantially perpendicular and adjacent to the ground so that the user can scoop trash or debris through the semi-circular opening 145 into the trash bag 120 securely held on the trash collecting device 110.

The top cover piece 130 and bottom retaining ring 133 of the trash collecting device 110 are preferably molded from a plastic resin such as, recycled acrylonitrile butadiene styrene (ABS) plastic, polystyrene or the like, but it should be apparent to those skilled in the art that they may be manufactured from other suitable materials. It may be preferable that the material used to form the top cover piece 130 and the bottom retaining ring 133 be durable and resilient. The material may be slightly resilient, in which case, the top cover piece 130 and the bottom retaining ring 133 will exhibit a resilient clamping action on the trash bag 120. The top cover piece 130 and bottom retaining ring 133 may be made in any color, for example, fluorescent orange, green or yellow. It is understood that many different bags designed for a variety of uses and from a variety of suppliers can be attached to the trash collecting device 110 and that the discussions regarding trash bags are merely exemplary. It is also understood that the trash collecting device 110 can be dimensioned to accommodate bags of different sizes and a variety of uses, including but not limited to, standard size trash and debris bags. It is further understood that the trash collecting device 110 enables the user to handle the debris and trash picking in a more sanitary situation.

Thus, it can be seen from the foregoing specification and attached drawings that the device of the present invention facilitates the use of a conventional thin plastic trash bag by holding it open so trash can be inserted therein. The positioning of the manually engageable handle 150 towards the center of the device provides stability to the device when held by the user.

It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

What is claimed:

1. A cover piece for a trash collecting device, the cover piece comprising:
a sidewall defining an interior region of the cover piece;
s a surface extending from the sidewall towards the interior region;
a handle connected to the surface; and
a first opening within the surface;
wherein the handle is positioned between the first opening and the sidewall; and
wherein the first opening comprises at least one extension of the first opening defining an open channel in the surface extending from the first opening towards the handle.

2. The cover piece according to claim 1, wherein the cover piece is configured for removable attachment to a retaining ring;
wherein the retaining ring is dimensioned to fit in a nested engagement within the interior region the cover piece; and
wherein the cover piece is configured to securely hold at least a portion of a bag when the retaining ring is placed in the nested engagement within the interior region of the cover piece.

3. The cover piece according to claim 2, wherein the cover piece further comprises at least one protrusion extending from the sidewall towards the interior region; and
wherein the at least one protrusion is configured to engage the retaining ring to securely hold the retaining ring in the nested engagement within the interior region of the cover piece.

4. The cover piece according to claim 2, wherein the cover piece and the retaining ring are formed from a resilient material so as to be configured to produce a resilient clamping action on the bag.

5. The cover piece according to claim 4, wherein the resilient material is comprised of a plastic resin.

6. The cover piece according to claim 1, wherein the handle comprises a rounded rod portion, and wherein the cover piece further comprises:
a second opening defined within the surface and positioned on a first side of the rounded rod portion; and
a third opening defined within the surface and positioned on a second side of the rounded rod portion opposite the first side of the rounded rod portion.

7. The cover piece according to claim 6, wherein the cover piece further comprises a rounded lip on the surface surrounding at least a portion of the first opening.

8. The cover piece according to claim 1, wherein the cover piece further comprises a tab extending from the sidewall in a direction away from the interior region.

9. A trash collecting device, comprising:
a cover piece comprising a sidewall defining an interior region of the cover piece, a surface extending from the sidewall towards the interior region, a handle connected to the surface, and a first opening within the surface; and
a retaining ring configured for removable attachment to the cover piece and dimensioned to fit in a nested engagement within the interior region of the cover piece;
wherein the handle is positioned between the first opening and the sidewall; and
wherein the first opening comprises at least one extension of the first opening defining an open channel in the surface extending from the first opening towards the handle.

10. The trash collecting device according to claim 9, wherein the handle comprises a rounded rod portion, and wherein the cover piece further comprises:
a second opening defined within the surface and positioned on a first side of the rounded rod portion; and
a third opening defined within the surface and positioned on a second side of the rounded rod portion opposite the first side of the rounded rod portion.

11. The trash collecting device according to claim 9, wherein the trash collecting device is configured to securely hold at least a portion of a bag between the retaining ring and the cover piece when the retaining ring is placed in the nested engagement within the interior region of the cover piece.

12. The trash collecting device according to claim 9, wherein the retaining ring comprises an inner surface, an outer surface, and a groove longitudinally defined at least over a portion of the outer surface.

13. The trash collecting device according to claim 12, wherein the cover piece comprises at least one protrusion extending from the sidewall towards the interior region, and wherein the groove of the retaining ring is dimensioned for receipt of the at least one protrusion.

14. The trash collecting device according to claim 13, wherein the groove and the at least one protrusion are configured to engage to securely hold at least a portion of the retaining ring within the interior region of the cover piece.

15. The trash collecting device according to claim 9, wherein the cover piece further comprises a tab extending from the sidewall in a direction away from the interior region.

16. The trash collecting device according to claim 9, wherein the retaining ring further comprises an extension dimensioned to extend from the cover piece when the retaining ring is placed in the nested engagement within the interior region of the cover piece.

17. The trash collecting device according to claim 11, wherein the cover piece and the retaining ring are formed from a resilient material so as to be configured to produce a resilient clamping action on the bag.

18. A method of collecting at least one piece of debris using a trash collecting device comprising a cover piece and a retaining ring, the method comprising:
inserting at least a portion of a bag having an opening between the cover piece and the retaining ring,
engaging the cover piece with the retaining ring to form a nested engagement of the retaining ring within the cover piece, wherein the nested engagement is configured to secure at least the portion of the bag to the trash collecting device and maintain the opening of the bag at least partially open,
wherein the cover piece comprises a sidewall defining an interior region of the cover piece, a surface extending from the sidewall towards the interior region, a handle connected to the surface, and a first opening within the surface,
wherein the handle is positioned between the first opening and the sidewall, and the first opening comprises at least one extension of the opening defining an open channel in the surface extending from the first opening towards the handle, and
wherein the method further comprises depositing the at least one piece of debris into the bag through the first opening.

19. The method according to claim 18, wherein the cover piece further comprises a tab extending from the sidewall in a direction away from the interior region, wherein the retaining ring further comprises an extension dimensioned to extend from the cover piece when the retaining ring is placed in the nested engagement within the interior region of the cover piece, and wherein the method further comprises releasing the cover piece from the retaining ring by urging the tab and the extension in substantially opposite directions.

20. The method according to claim 18, wherein the cover piece further comprises a second opening defined within the surface and positioned on a first side of the handle, and a third opening defined within the surface and positioned on a second side of the handle opposite the first side of the rounded rod portion, and wherein the method further comprises manipulating a position of the trash collecting device through use of the handle.
